(19) United States
(12) Patent Application Publication
(10) Pub. No.: US 2010/0218865 A1
(43) Pub. Date: Sep. 2, 2010

(54) AIRPLANE TIRE WITH AIR POCKET

(76) Inventor: Sung Bae Kim, Seoul (KR)

Correspondence Address: HYUN JONG PARK;Park & Associates IP Law LLC, 265 Bic Drive, Suite 106, Milford, CT, 06461, US

(21) Appl. No.: 12/161,752

(22) PCT Filed: Aug. 23, 2006
(86) PCT No.: PCT/KR2006/003308

§ 371 Date: Jul. 22, 2008

(30) Foreign Application Priority Data
Jan. 24, 2006 (KR) 20-2006-0002194

(51) Int. Cl. B60C 11/03

(52) U.S. Cl. 152/209.1

(57) ABSTRACT

Disclosed is an airplane tire, and more particularly, is an airplane tire having air pockets, which can allow a tire wheel to rotate using the resistance of air depending on the speed of an airplane upon landing. The airplane tire can alleviate the landing shock of the tire and preventing wear and deformation of the tire by friction. In particular, the airplane tire can shorten a damping distance by virtue of an increased frictional force thereof when an airplane body stops using a tire wheel brake and achieve generation of a sufficient centrifugal force by rotation, thereby contributing to the safe flying of an airplane and the elimination of environmental pollution.

### TECHNICAL FIELD

The present invention relates to an airplane tire, and more particularly, to an airplane tire having air pockets, which can allow a tire wheel to rotate using the resistance of air depending on the speed of an airplane upon landing, thereby alleviating the landing shock of the tire against the ground and preventing wear and deformation of the tire by frictional heat, and in particular, which can shorten a damping distance by virtue of an increased frictional force thereof when an airplane body stops using a tire wheel brake and achieve generation of a sufficient centrifugal force by rotation, thereby contributing to the safe flying of an airplane.

### BACKGROUND ART

In general, an airplane wheel is the most important airplane component in charge of takeoff and landing of an airplane. The wheel and associated peripheral devices are collectively called as a landing gear. To reduce the resistance of air, most airplanes try to fold the landing gear immediately on takeoff, and unfold the landing gear right before landing. As the landing gear is unfolded, a wheel coupled to the landing gear touches down a landing strip, for leading safe landing of an airplane. Airplanes travel at a high speed upon landing such that the speed of the airplane at the moment when the wheel touches down on a landing strip is 250˜350 kilometers per an hour. Therefore, the wheel of the airplane is subjected to an enormous centrifugal force upon landing. Since the airplane wheel is basically affected by a load due to a heavy airplane body, the centrifugal force disadvantageously acts to increase the load.

The increased wheel load causes a variation in the internal energy of the wheel (hereinafter, referred to as “tire”), resulting in repetitive fatigue and serious heat accumulation phenomenon. The repetitive fatigue and heat accumulation phenomenon have a bad effect on physical properties of a material, thus causing deterioration of the physical properties. Accordingly, rubber layers of a tire may suffer from separation or cracking. Further, due to the fact that a conventional airplane wheel is in a stationary state at the time when a tire touches down on a landing strip, a face of the tire coming into contact with a landing strip has significant friction and wear. If the tire is deformed by frictional heat, it causes a reduction in the lifespan of the tire and consequently, uneconomical frequent exchange of the tire. Furthermore, dust particles generated by the friction and wear of the tire have a problem of environmental pollution of the surroundings. Using a worn tire results in violent shaking of the airplane body, and in the worst case, may result in dangerous airplane accidents by the rupture of the tire.

### DISCLOSURE OF INVENTION

### Technical Problem

Therefore, the present invention has been made in view of the above problems, and it is an object of the present invention to provide an airplane tire having air pockets, which can allow a wheel to rotate naturally in a landing direction by use of the resistance of air depending on the speed of an airplane, thereby achieving a remarkable reduction in the shock applied to a tire upon landing and reducing the wear of the tire while guaranteeing the uniform wear of the tire and consequently, increasing the lifespan of the wheel, and preventing environmental pollution via generation of a reduced amount of dust particles due to the friction and wear of the tire, and in particular, which can shorten a damping distance by virtue of an increased frictional force of the tire when an airplane body stops using a wheel brake and achieve generation of a sufficient centrifugal force by rotation, thereby contributing to the safe flying of an airplane.

### Technical Solution

In accordance with an aspect of the present invention, the above and other objects can be accomplished by the provision of an airplane tire in which a plurality of rows of air pockets, each air pocket having a recess of a predetermined-depth, are formed at an outer circumferential surface of the airplane tire. Here, the air pockets may be modified in various manners.

### Advantageous Effects

As described above, with the configuration of an airplane tire according to the present invention in which a plurality of rows of air pockets, each air pocket having a recess of a predetermined-depth, are formed at an outer circumferential surface of the airplane tire, it is possible to allow a wheel to rotate naturally in a landing direction by use of the resistance of air depending on the speed of an airplane. This has the effects of achieving a remarkable reduction in the shock applied to a tire upon landing and reducing the wear of the tire and guaranteeing the uniform wear of the tire, so as to increase the lifespan of the wheel. Also, according to the present invention, a damping distance can be shorten by virtue of an increased frictional force of the tire when an airplane body stops using a wheel brake and the tire can generate a sufficient centrifugal force via rotation thereof. This has the effect of contributing to the safe flying of an airplane, preventing environmental pollution via generation of a reduced amount of dust particles due to the friction and wear of the tire and improving the economic efficiency of the tire by virtue of the increased lifespan.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a side view and a front view illustrating the configuration of one embodiment of the present invention;

FIGS. 3, 4, and 5 are a side view and front views illustrating the configuration of another embodiment of the present invention;

FIG. 6 is a side view illustrating the configuration of a further embodiment of the present invention;

FIGS. 7 and 8 are a side view and a front view illustrating the configuration of a still further embodiment of the present invention; and

FIGS. 9 and 10 are side views illustrating the configuration of other different embodiments of the present invention.

### DESCRIPTION OF REFERENCE NUMERALS TO THE DRAWINGS

1: tire 2, 2a, 2b, 2c, 2d, 2e,
2: air pocket
3: air induction path
4: air confluence recess
5: disc

### BEST MODE FOR CARRYING OUT THE INVENTION

Now, the configuration of the present invention will be described in detail with reference to the accompanying drawings.

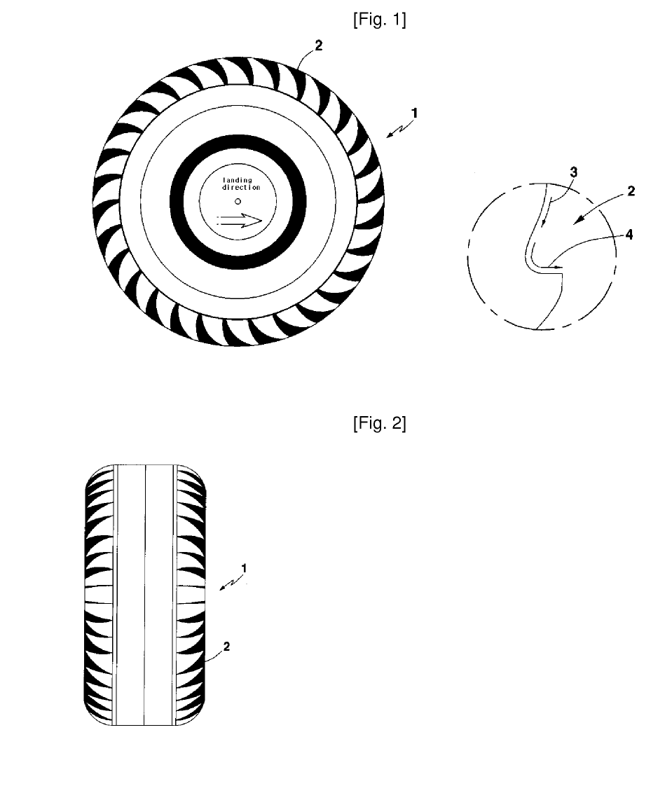

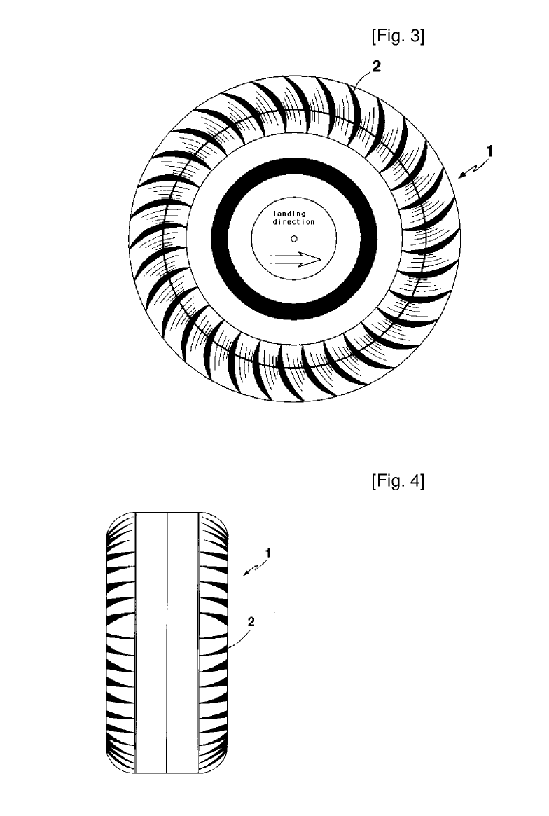

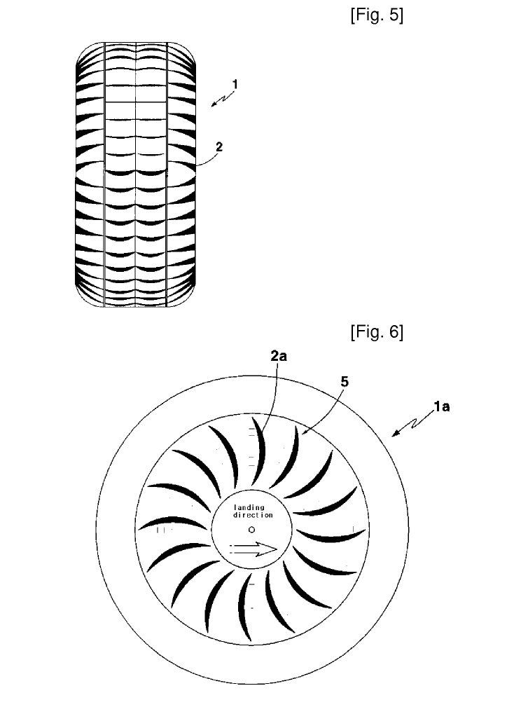

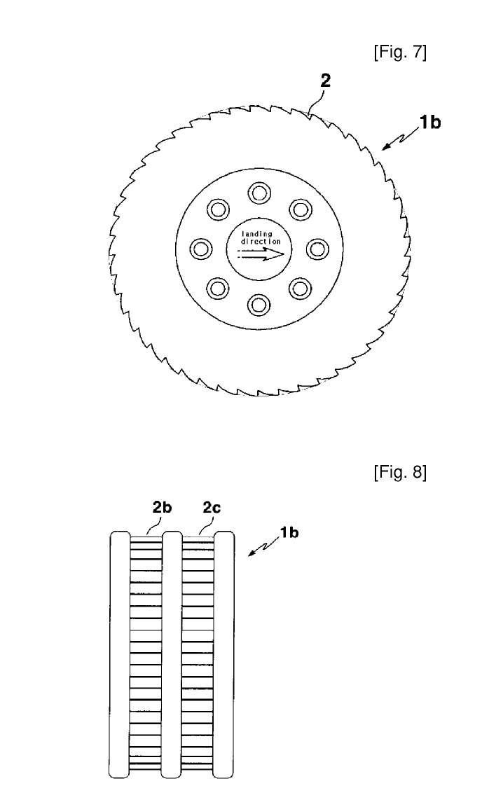

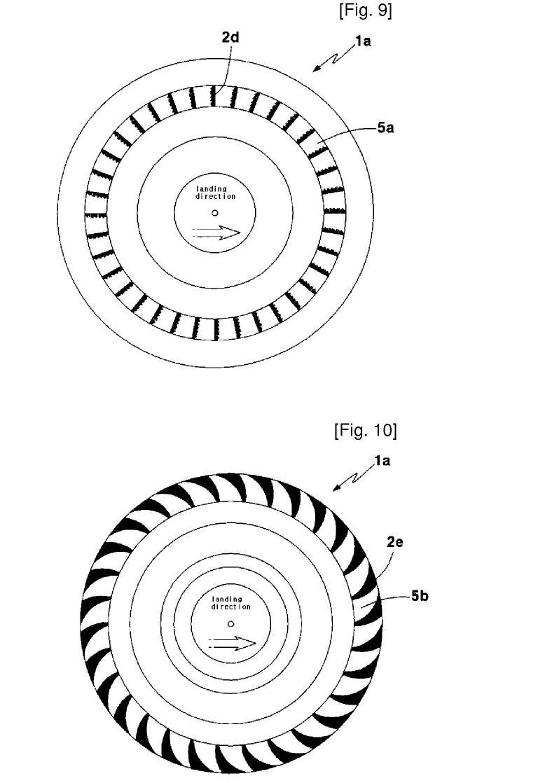

FIGS. 1 and 2 are a side view and a front view illustrating an airplane wheel according to one embodiment of the present invention. FIGS. 3, 4, and 5 are a side view and front views illustrating an airplane wheel according to another embodiment of the present invention. FIG. 6 is a side view of a further embodiment of the present invention, illustrating a state in which a separate disc having air pockets radially formed therein is attached to a side surface of a conventional airplane tire. FIGS. 7 and 8 are a side view and a front view of a still further embodiment of the present invention, illustrating toothed air pockets are formed at an outer circumferential surface of a tire at opposite sides of an imaginary center line of the circumferential surface. FIGS. 9 and 10 are side views of other different embodiments of the present invention, illustrating a separate disc having toothed air pockets or radial air pockets is attached to a side surface of a conventional airplane tire.

The airplane tire 1 according to the present invention has a tread pattern in which a plurality of rows of air pockets 2, each air pocket having a recess of a predetermined depth, are formed in opposite edge faces of the tire 1 about a center ground-contact surface to keep a predetermined interval therebetween. Alternatively, the airplane tire 1 may have a tread pattern in which the plurality of rows of air pockets 2, each air pocket having a recess of a predetermined depth, are formed at the center ground-contact surface to keep the predetermined interval therebetween. Each of the air pockets 2 has an air induction path 3 formed at an air access portion thereof and an inner air confluence recess 4. In consideration of factors having an effect on the safety of the tire, the air pocket 2 may be formed by embossed carving. This is to eliminate deterioration in the strength of the tire due to engraving carving.

### MODE FOR THE INVENTION

In accordance with other different embodiments of the present invention, a disc 5 or 5b, which is radially formed with air pockets 2a or 2e, may be attached to the center of a side surface of a conventional airplane tire 1a (See FIG. 6), or may be attached to the edge of an outer circumferential surface of the tire 1a (See FIG. 10). Alternatively, toothed air pockets 2b or 2c may be formed at an outer circumferential surface of the tire 1b at opposite sides of an imaginary center line of the circumferential surface. As an alternative configuration of the above described embodiments using the separate disc, toothed air pockets 2d may be formed at a separate disc 5a.

### INDUSTRIAL APPLICABILITY

As apparent from the above description, in a state in which an airplane tire has a plurality of air pockets each having an air induction path and an inner air confluence recess, if a tire comes out from the bottom of an airplane body as a landing gear is unfolded right before the landing of an airplane, air streams, which are created by the resistance of air depending on the speed of an airplane, merge into the air confluence recesses of the air pockets by way of the air induction paths, thereby causing the tire to be naturally rotated in a landing direction as designated by an arrow in the drawings. This has the effect of reducing the shock caused when the tire touches down on a landing strip, and preventing deformation of a wheel and reducing the wear of the tire while guaranteeing uniform wear of the tire, resulting in an increase in the lifespan of the tire. In addition, when the airplane body stops on a landing strip by use of a wheel brake, the present invention can shorten a damping distance by virtue of an increased frictional force of the tire, and prevent the rupture of the tire, thereby contributing to the safety flying of the airplane while preventing the problem of environmental pollution.

Furthermore, in accordance with other various embodiments of the present invention, a disc having radially formed or toothed air pockets may be attached to the center of a side surface of a conventional airplane tire having no air pockets or to the edge of an outer circumferential surface of the conventional airplane tire. In this case, the air pockets have the same operational effect as the air pockets directly formed in the airplane tire. Similarly, it will be appreciated that, even when toothed air pockets are formed at opposite sides of the tire in a circumferential direction, it is possible to accomplish the same operational effect as the above description. This configuration is efficient to reduce the wear of the tire.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An airplane tire having air pockets, wherein the airplane tire has a tread pattern in which a plurality of rows of air pockets, each air pocket having a recess of a predetermined-depth, are formed at opposite edge faces of the tire about a center ground-contact face of the tire to keep a predetermined interval therebetween.

2. The airplane tire according to claim 1, wherein the airplane tire has a tread pattern in which the plurality of rows of air pockets, each air pocket having the recess of the predetermined-depth, are formed at the center ground-contact surface of the tire to keep the predetermined interval therebetween.

3. The airplane tire according to claim 1, wherein, instead of forming the air pockets at the tire, a disc, having radially formed air pockets or toothed air pockets, is attached to the center of a side surface of the tire or to the edge of an outer circumferential surface of the tire.

4. The airplane tire according to claim 1, wherein toothed air pockets are formed at an outer circumferential surface of the tire at opposite sides of an imaginary center line of the circumferential surface.
